(19) United States
(12) Patent Application Publication
(10) Pub. No.: US 2014/0150190 A1
(43) Pub. Date: Jun. 5, 2014

(54) REFILL HEAD FOR AN ORAL CARE IMPLEMENT HANDLE

(71) Applicant: Joseph E. Fattori, East Sandwich, MA (US)

(72) Inventor: Joseph E. Fattori, East Sandwich, MA (US)

(73) Assignee: COLGATE-PALMOLIVE COMPANY, New York, NY (US)

(21) Appl. No.: 14/232,254

(22) PCT Filed: Feb. 3, 2012
(86) PCT No.: PCT/US12/23776

§ 371 Date: Jan. 11, 2014

Related U.S. Application Data
(60) Provisional application No. 61/506,959, filed on Jul. 12, 2011.

(51) Int. Cl. A61C 17/22; A61C 17/34

(52) U.S. Cl. CPC A61C 17/222; A61C 17/3481; A61C 17/225
USPC 15/22.1; 15/145

(57) ABSTRACT

A refill head, and oral care implement incorporating the same, wherein the refill head comprises a tubular sleeve having a cavity for slidably receiving a stem of a handle of the oral care implement. An aperture in the tubular sleeve defines a latch having a locking lug that operably mates with a locking lug of the stem to axially retain the refill head to the handle. A resilient material seals the aperture to provide increased rigidity to the latch.

### CROSS-REFERENCE TO RELATED APPLICATIONS

The present application claims the benefit of U.S. Provisional Patent Application Ser. No. 61/506,959, filed on Jul. 12, 2011, the content of which is hereby incorporated by reference in its entirety.

### FIELD OF THE INVENTION

The present invention relates generally to refill heads for oral care implements, and specifically to the coupling structure of the refill head.

### BACKGROUND OF THE INVENTION

Powered toothbrushes having replaceable heads, commonly referred to as refill heads, are known in the art. Such powered toothbrushes typically include a handle and a refill head that is detachably coupled to the handle. The replaceability of the heads in such powered toothbrushes is desirous because the handle, which includes the expensive motion-inducing circuitry and components, is expensive to manufacture and has a much longer life expectancy than do the cleaning elements, such as bristles, that are on the head. Consumers would not be willing to pay a premium to purchase such powered toothbrushes if they had to be discarded when the bristles or other cleaning elements wore out. Thus, it is now standard in the industry to provide refill heads that can be attached and detached from the handle so that worn out refill heads can be replaced as needed for the same handle.

Existing refill heads suffer from a number of deficiencies, including complexity of manufacture, the ability to improperly load the refill head to the handle, and inadequate coupling of the refill head to the handle. Thus, a need exist for a refill head having an improved coupling structure.

### BRIEF SUMMARY OF THE INVENTION

The present invention is directed to a refill head, and oral care implement incorporating the same, wherein the refill head comprises a tubular sleeve having a cavity for slidably receiving a stem of a handle of the oral care implement. An aperture in the tubular sleeve defines a latch having a locking lug that operably mates with a locking lug of the stem to axially retain the refill head to the handle. A resilient material seals the aperture to provide increased rigidity to the latch.

In one embodiment, the invention can be a toothbrush comprising: a handle comprising: a gripping portion; and a stem extending from the gripping portion, the stem extending along an axis, the stem comprising a locking lug extending radially outward from an outer surface of the stem; a refill head detachably coupled to the handle, the refill head comprising: a head portion comprising a plurality of tooth cleaning elements; a tubular sleeve coupled to the head portion, the tubular sleeve having a cavity in which the stem is disposed, the tubular sleeve comprising an aperture defining a latch in the tubular sleeve, the latch comprising a locking lug protruding into the cavity; and a strip of resilient material on an outer surface of the tubular sleeve that seals the aperture and covers the latch; and wherein the locking lug of the latch operably mates with the locking lug of the stem to axially retain the stem within the cavity.

In another embodiment, the invention can be a refill head for an oral care implement comprising: a head portion; a tubular sleeve coupled to the head portion, the tubular sleeve having a cavity extending along an axis, the tubular sleeve comprising an aperture defining a latch in the tubular sleeve, the latch comprising a locking lug protruding into the cavity; and a resilient material disposed within and sealing the aperture; and wherein the latch is configured to flex radially outward from a locked state to an unlocked state, the latch biased into the locked state.

In yet another embodiment, the invention can be a refill head for an oral care implement comprising: a head portion; a tubular sleeve coupled to the head portion, the tubular sleeve having a cavity extending along an axis, the tubular sleeve comprising a closed-perimeter aperture defining a latch in the tubular sleeve, the latch comprising a locking lug protruding into the cavity; and a resilient material sealing the aperture.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front view of a refill head and a toothbrush handle in alignment for detachable coupling according to one embodiment of the present invention, wherein the refill head is shown in longitudinal cross-section and the toothbrush handle is in partial longitudinal cross-section;

FIG. 2 is a longitudinal cross-sectional view of the refill head according to one embodiment of the present invention;

FIG. 3 is a right-side view of a proximal portion of the refill head of FIG. 1 illustrating the latch structure of the refill head;

FIG. 4 is a longitudinal cross-sectional view of the refill head and the toothbrush handle of FIG. 1 detachably coupled together according to one embodiment of the present invention;

FIG. 5 is a transverse cross-section of the toothbrush of FIG. 4 taken along view V-V;

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

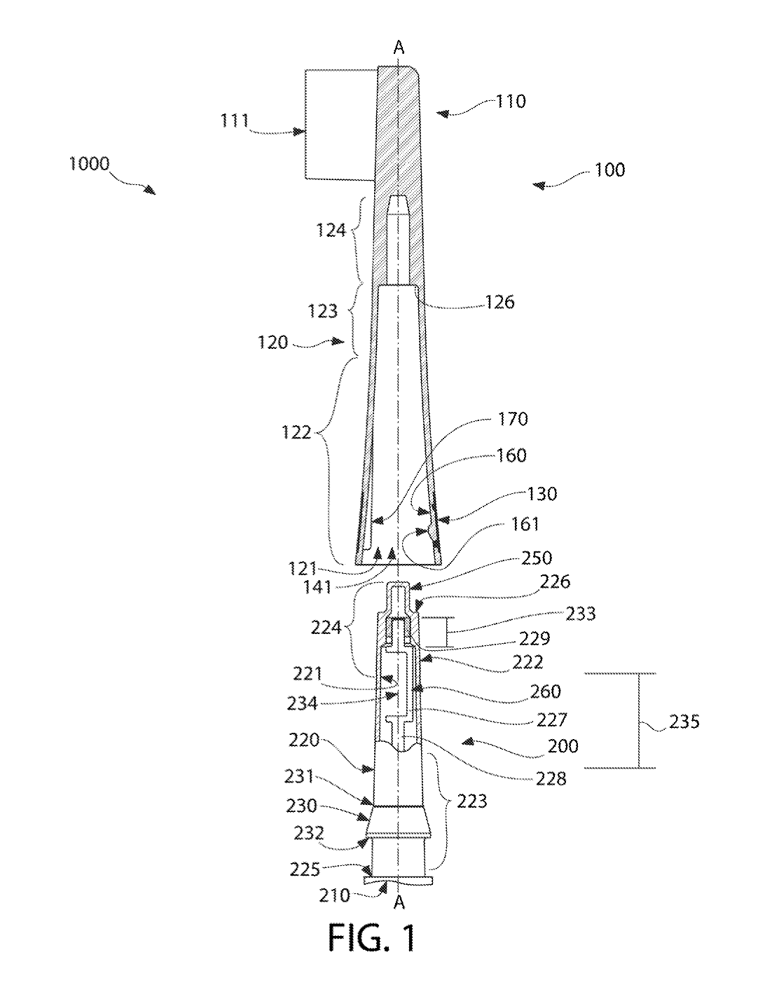

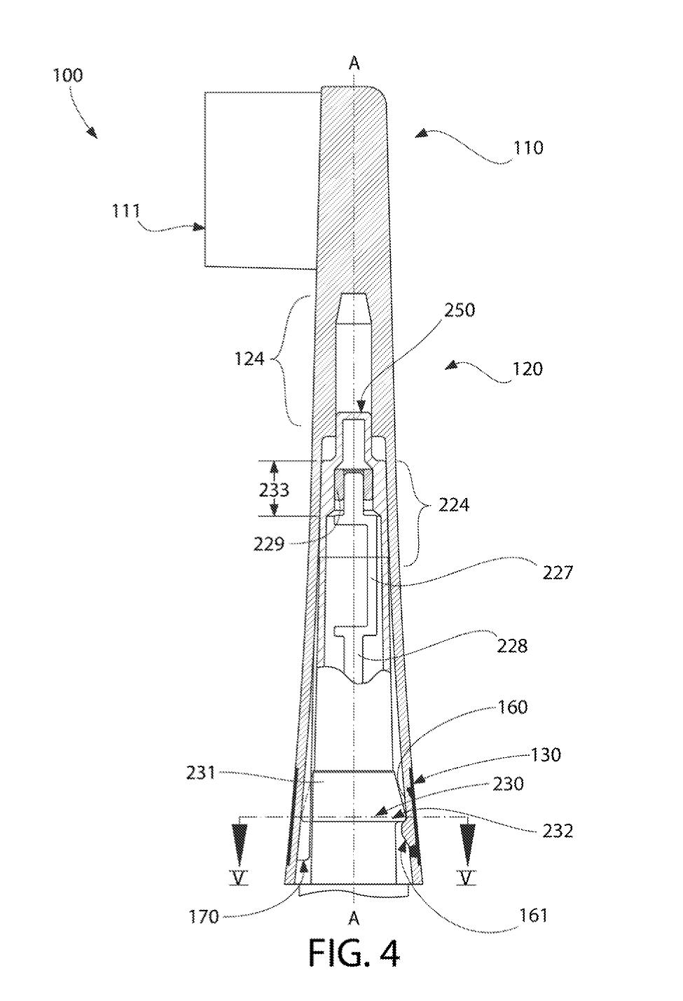

Referring to FIGS. 1 and 4 concurrently, a powered toothbrush 1000 according to one embodiment of the present invention is illustrated. The powered toothbrush 1000 generally comprises a refill head 100 and a handle 200. As discussed in greater detail below, the refill head 100 and the handle 200 are designed so that the refill head 100 can be repetitively coupled to and uncoupled from the handle 200. In FIG. 1, the powered toothbrush 1000 is illustrated wherein the refill head 100 is not coupled to the handle 200 but is in axial alignment with the handle 200 so that such coupling can be effectuated. In FIG. 4, the powered toothbrush 1000 is illustrated wherein the refill head 100 is coupled to the handle 200 according to an embodiment of the present invention.

While the invention is exemplified herein as a powered toothbrush 1000, it is to be understood that the inventive concepts discussed herein can be applied to manual toothbrushes that utilize refill heads, or other manual or powered oral care implements, including without limitation tongue cleaners, water picks, interdental devices, tooth polishers and specially designed ansate implements having tooth engaging elements.

Referring now to FIGS. 1, 3 and 4 concurrently, the handle 200 will be described in greater detail. The handle 200 generally comprises a gripping portion 210 (only a small portion of which is exemplified), a stem 220 and an alignment plug 250. The stem 220 extends from the gripping portion 210 along a longitudinal axis A-A.

The gripping portion 210 of the handle 200 is an elongated structure that provides the mechanism by which the user can hold and manipulate the toothbrush 1000 during use. The gripping portion 210 can take on a wide variety of shapes, contours and configurations, none of which are limiting of the present invention. Included within the gripping portion 210 is a power source, a motor and electrical circuitry and components necessary to create a desired motion within the refill head 100. In the exemplified embodiment, the desired motion is a vibratory motion.

The gripping portion 210 also includes the user interface that controls the various operations of the toothbrush 1000, including without limitation turning off and on, changing speeds of the motor, or other included functions. The gripping portion 210, in essence, forms a watertight housing for the aforementioned electrical circuit and mechanical components that need to be protected from moisture.

In the exemplified embodiment, the motion to be transmitted to the head portion 110 of the refill head 100 is a vibratory motion. In order to generate such vibratory motion, the handle 200 comprises a vibratory element 260, which in the exemplified embodiment is in the form of an eccentric 227 coupled to a drive shaft 228. A proximal portion (not illustrated) of the drive shaft 228 is operably coupled to the electric motor (not illustrated) so that the electric motor can rotate the drive shaft 228. A distal portion 233 of the drive shaft 228 is retained by an annular bearing 229 which is mounted within the stem 220. As the drive shaft 228 is rotated, the eccentric 227, due to its off-center center of gravity, generates vibrations that are transmitted to the stem 220 and to the refill head 100 (discussed in greater detail below). While the eccentric 227 is exemplified as a portion of the drive shaft 228 that is radially offset from the longitudinal axis A-A, the invention is not so limited. In other embodiments, the eccentric 227 may be an offset disc or other offset weight, as is known in the art. As can be seen in FIG. 1, the stem 220 forms a watertight housing having an internal cavity 234 in which the drive shaft 228 and eccentric 227 are housed. Additional details of a suitable vibratory producing handle, and related structure that can be incorporated into the powered toothbrush 1000 of the present invention, can be found in U.S. Patent Application Publication No. 2010/0269275, Shimoyama et al., published Oct. 28, 2010 (filed as U.S. patent application Ser. No. 12/377,355), the entirety of which is hereby incorporated by reference.

Referring to FIGS. 1 and 4, the stem 220 of the handle 200 will be described in greater detail. The stem 220 is an elongated structure that is integrally formed to be repetitively coupled to and decoupled from a cavity 121 of the head 100. The stem 220 comprises a proximal portion 223, a middle portion 235 and a distal portion 224. The proximal portion 223 is the base portion of the stem 220 that is adjacent the gripping portion 210 of the handle 200. The distal portion 224 forms the free end of the stem 220 while the middle portion 235 is located axially between the proximal portion 223 and the distal portion 224.

The stem 220 further comprises an inner surface 221, an outer surface 222, a proximal end 225, a distal end 226, a locking lug 230, an axial slot 240 and a vibratory element 260. The stem 220 is an elongated structure that extends from the gripping portion 210 along the axis A-A. The stem 220 features components that enable the handle 200 to be repeatedly coupled to and decouple from the handle 200. In the exemplified embodiment, the stem 220 comprises the locking lug 230 that is located on the proximal portion 223, or base portion, of the stem 220. However, the invention is not so limited and in alternate embodiments the locking lug 230 may be axially located on a different portion of stem 220.

The locking lug 230 extends radially outward from the outer surface 222 of the stem 220 and provides a mechanism by which the handle 200 may be coupled to the refill head 100. The locking lug 230 generally comprises an upper surface 231 and a lower surface 232. The upper surface 231 of the locking lug 230 is oblique to the axis A-A, while the lower surface 232 of the locking lug 230 is substantially perpendicular to the axis A-A. In the exemplified embodiment, the locking lug 230 is an annular flange that substantially circumscribes the stem 220. The invention, however, is not so limited and in alternate embodiments the locking lug 230 may be any protuberance, including, but not limited to, a flange that only partially circumscribes the stem 220.

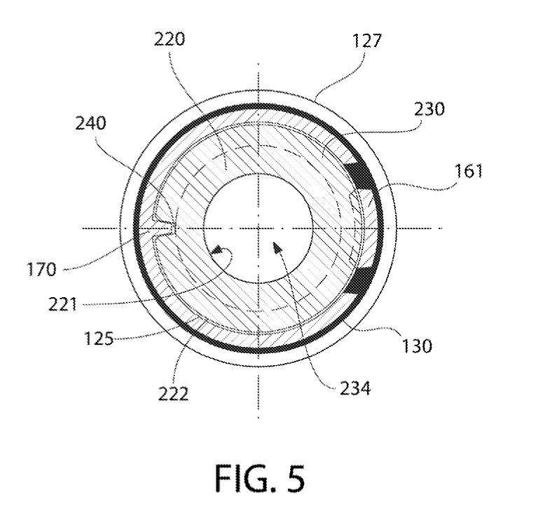

Referring to FIG. 5, the axial slot 240 of the stem 220 is illustrated. The axial slot 240 is a radial opening or void in the locking lug 230 that is configured to mate with an axial rib 170 of the tubular sleeve 120 of the head 100 when the stem 220 and head 100 are coupled together. When coupled together, the mating of the axial slot 240 and the axial rib 170 ensures that the relative rotational orientation between the head 100 and the handle 200 is maintained.

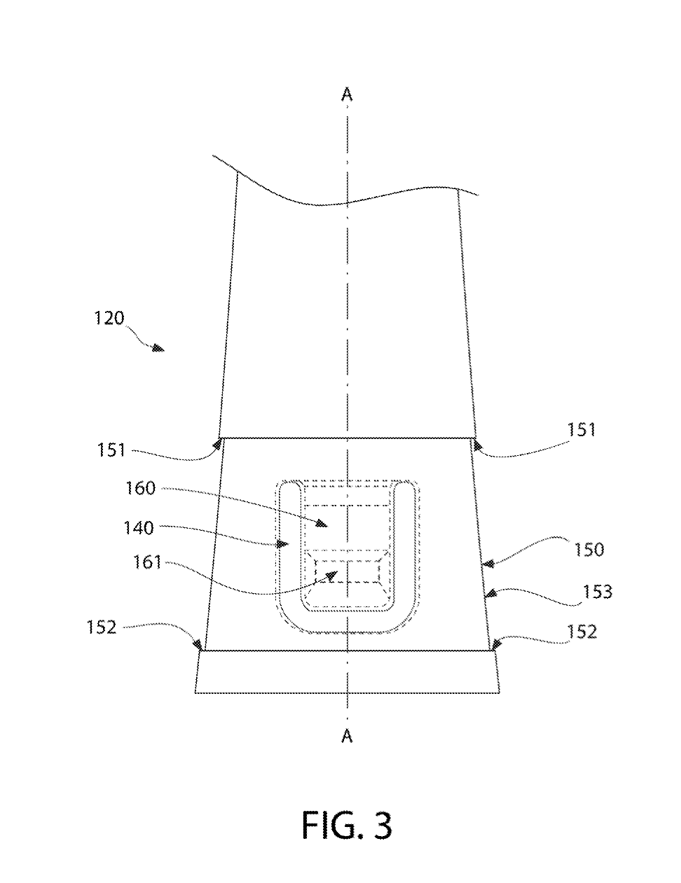

Referring back to FIGS. 1 and 3, the alignment plug 250 extends from the distal end of the distal portion 224 of the stem 220 along the axis A-A. The alignment plug 250 is configured to extend into the distal axial section 124 of the cavity 121 of the refill head 100 when the stem 220 and head 100 are coupled together.

The vibratory element 260 is operably coupled to the power source and configured to create the desired motion within the refill head 100 when the handle 200 is coupled to the head 100. Although the vibratory element 260 is illustrated within the stem 220 of the handle 200, it should be noted that in alternate embodiments the vibratory element 260 may be omitted or located within another portion of the powered toothbrush 1000.

Referring to FIGS. 1, 2 and 3 concurrently, the refill head 100 of the powered toothbrush 1000 will be described in more detail. The refill head 100 generally comprises a head portion 110, a tubular sleeve 120 and a strip of resilient material 130. As noted above, the refill head 100 is designed and configured for detachable coupling to the handle 200 so that the refill head 100 can be replaced with a new refill head when it becomes worn and no longer effectively cleans a user's teeth and other oral surfaces. In other words, by enabling the powered toothbrush 1000 to have refill heads 100 that can be detachably coupled to the handle 200, the entire powered toothbrush 1000 does not need to be replaced when the tooth engaging elements 111 on the refill head 100 become worn out. The mechanical operability of the powered toothbrush 1000 is housed within the handle 200 as has been described above. Therefore, enabling reuse of the handle 200 with a new refill head 100 minimizes the costs to a user when the tooth engaging elements 111 of the refill head 100 become worn by only requiring the user to replace the refill head 100 rather than the handle 200 and all of the expensive internal circuitry housed therein.

In the exemplified embodiment, the tubular sleeve 120 and the head portion 110 of the refill head 100 are integrally formed as a single unitary structure using a molding, milling, machining or other suitable process. However, in other embodiments the head portion 110 and the tubular sleeve 120 of the refill head 100 may be formed as separate components which are operably connected at a later stage of the manufacturing process by any suitable technique known in the art, including without limitation thermal or ultrasonic welding, a tight-fit assembly, a coupling sleeve, threaded engagement, adhesion, or fasteners.

The head portion 110 of the refill head 100 comprises a plurality of tooth cleaning elements 111 extending therefrom for cleaning and/or polishing contact with an oral surface and/or interdental spaces. The head portion 110 of the refill head 100 is generally formed of a material that is rigid, such as a moldable hard plastic. Suitable hard plastics include polymers and copolymers of ethylene, propylene, butadiene, vinyl compounds and polyesters such as polyethylene terephthalate. Of course, the invention is not to be so limited and other moldable hard plastics can be used to form the head portion 110 of the refill head 100.

In the exemplified embodiment, the tooth engaging elements 111 are generically illustrated. While the collection of tooth engaging elements 111 is suited for brushing teeth, the collection of tooth engaging elements 111 can also be used to polish teeth instead of or in addition to cleaning teeth. As used herein, the term “tooth engaging elements” is used in a generic sense to refer to any structure that can be used to clean, polish or wipe the teeth and/or soft oral tissue (e.g. tongue, cheek, gums, etc.) through relative surface contact. Common examples of “tooth engaging elements” include, without limitation, bristle tufts, filament bristles, fiber bristles, nylon bristles, spiral bristles, rubber bristles, elastomeric protrusions, flexible polymer protrusions, combinations thereof and/or structures containing such materials or combinations. Suitable elastomeric materials include any biocompatible resilient material suitable for uses in an oral hygiene apparatus. To provide optimum comfort as well as cleaning benefits, the elastomeric material of the tooth or soft tissue engaging elements has a hardness property in the range of A8 to A25 Shore hardness. One suitable elastomeric material is styrene-ethylene/butylene-styrene block copolymer (SEBS) manufactured by GLS Corporation. Nevertheless, SEBS material from other manufacturers or other materials within and outside the noted hardness range could be used.

The tooth engaging elements 111 of the present invention can be connected to the head 100 in any manner known in the art. For example, staples/anchors, in-mold tufting (IMT) or anchor free tufting (AFT) could be used to mount the cleaning elements/tooth engaging elements. In AFT, a plate or membrane is secured to the brush head such as by ultrasonic welding. The bristles extend through the plate or membrane. The free ends of the bristles on one side of the plate or membrane perform the cleaning function. The ends of the bristles on the other side of the plate or membrane are melted together by heat to be anchored in place. Any suitable form of cleaning elements may be used in the broad practice of this invention. Alternatively, the bristles could be mounted to tuft blocks or sections by extending through suitable openings in the tuft blocks so that the base of the bristles is mounted within or below the tuft block.

Referring to FIGS. 1, 2 and 4, the tubular sleeve 120 will be described in more detail. The tubular sleeve 120 is coupled to the head portion 110 and is configured to receive the stem 220 of the handle 200. The tubular sleeve 120 comprises an inner surface 125, an outer surface 126, a proximal end 127, a distal end 128, a cavity 121, an aperture 140, an annular groove 150 and an axial rib 170. The distal end 128 of the tubular sleeve 120 is coupled to the head portion 110. The tubular sleeve 120 of the refill head 100 is generally formed of a material that is rigid, such as a moldable hard plastic. Suitable hard plastics include polymers and copolymers of ethylene, propylene, butadiene, vinyl compounds and polyesters such as polyethylene terephthalate. Of course, the invention is not to be so limited and other moldable hard plastics can be used to form the tubular sleeve 120 of the refill head 100.

The cavity 121 of the tubular sleeve 120 comprises a proximal axial section 122, a middle axial section 123, a distal axial section 124 and an opening 141. The cavity 121 is sized and shaped to accommodate the stem 220 of the handle 200 so that the refill head 100 can be detachably couple to the handle 200 as described below. The proximal axial section 122 has a tapered transverse cross-sectional area along its length. The middle axial section 123 has a slightly less tapered transverse cross-sectional area along its length moving from the proximal axial section 122 to a shoulder 136 that defines the end of the middle axial section 123 and the beginning of the distal axial section 124. The distal axial section 124 has a substantially constant cross-sectional area and the smallest transverse cross-sectional area.

The cavity 121 tapers from a proximal end 129 of the proximal axial section 122 to a distal end 131 of the distal axial section 124. Further, the proximal end 129 of the proximal axial section 122 of the cavity 121 has the opening 141 for receiving the stem 220. Therefore, the stem 220 of the handle 200 is received by the cavity 121 through the opening 141.

Referring to FIGS. 1, 2, 4 and 5, the aperture 140 will be described in more detail. The aperture 140 of the tubular sleeve 120 defines a latch 160. As shown in FIGS. 1, 2, 4 and 5, the aperture 140 is sealed by a strip of resilient material 130. However, FIG. 3 illustrates the aperture 140 not sealed or covered by the strip of resilient material 130. As shown in the exemplified embodiment of FIG. 3, the aperture 140 is a continuous opening in the tubular sleeve 120 that is substantially U-shaped or substantially V-shaped and has a closed perimeter. However, it should be noted that in alternate embodiments the tubular sleeve may comprise more than one aperture 140 or the aperture 140 may be any shape suitable to define the latch 160.

The latch 160 is located within the proximal axial section 122 of the tubular sleeve 120 and comprises a locking lug 161 protruding into the cavity 121. The latch 160 extends from a proximal edge 162 to a distal edge 163 and is integrally molded with the tubular sleeve 120. The proximal edge 162 of the latch 160 forms a living hinge, while the distal edge 163 of the latch 160 is a free edge. The latch 160 is configured to flex radially outward during the loading and unloading of the refill head 100 to the handle 200 due to contact between the locking lug 230 of the stem 220 and the locking lug 161 of the latch 160. Therefore, the latch 160 is configured to move between a locked state and an unlocked state.

In the locked state, the locking lug 161 of the latch 160 is operably mated with the locking lug 230 of the stem 220 (shown in FIGS. 4 and 5), or the stem 220 of the handle 200 and the tubular sleeve 120 of the head 100 are decoupled (shown in FIG. 1). In the unlocked state, the latch 160 is flexed radially outward due to contact between the locking lug 161 of the latch 160 and the locking lug 230 of the stem 220 (not shown). As discussed in more detail below, the latch 160 enters the unlocked state during the assembling and decoupling of the refill head 100 and handle 200. Therefore, if the powered toothbrush 1000 is assembled, the latch 160 enters the unlocked state when the consumer pulls upward on the refill head 100 causing the locking lug 161 of the latch 160 to ride up and over the lower surface 232 of the locking lug 230 of the stem 220. Further, it should be noted that the latch 160 is biased in the locked state. Therefore, when the refill head 100 and handle 200 are coupled together, the latch 160 is biased to keep the locking lug 161 of the latch 160 operably mated with the locking lug 230 of the stem 220 to axially retain the stem 220 within the cavity 121.

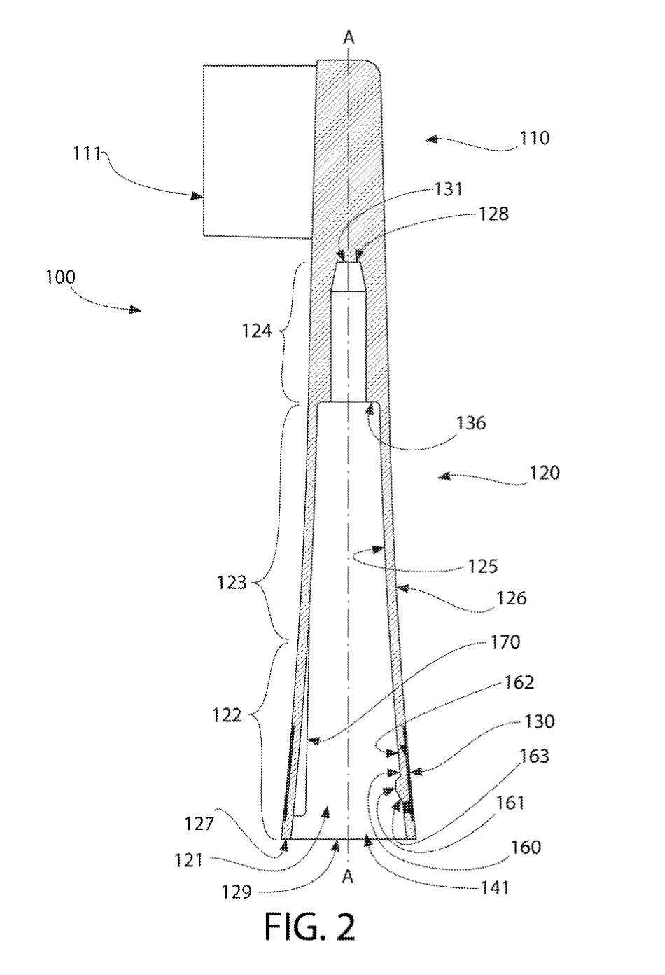

Referring to FIGS. 1, 2, 4 and 5, the axial rib 170 will now be described in more detail. The axial rib 170 is a protuberance that extends radially inward from the inner surface 125 of the tubular sleeve 120. In the exemplified embodiment of FIG. 2, the axial rib 170 tapers from the proximal axial section 122 to the middle axial section 123. As mentioned above and illustrated in FIGS. 4-5, the axial rib 170 is configured to mate with the axial slot 240 to maintain relative rotational orientation between the stem 220 and the tubular sleeve 120. Therefore, when the head 100 and handle 200 are coupled together, the inner surface 125 of the tubular sleeve 120 and the outer surface 222 of the stem 220 are keyed to maintain relative rotational orientation between the stem 220 and the tubular sleeve 120.

Referring to FIG. 3, a right-side view of a proximal portion 122 of the refill head 100 of FIG. 1 illustrating the latch structure 160 of the refill head 100 according to one embodiment of the present invention is illustrated. It should be noted that the strip of resilient material 130 is not illustrated in FIG. 3. FIG. 3 illustrates the annular groove 150 of the tubular sleeve 120. In the exemplified embodiment, the annular groove 150 circumscribes the tubular sleeve 120 and comprises an upper transverse wall 151, a lower transverse wall 152 and a floor 153. The latch 160 is defined in the floor 153 of the annular groove 150. However, the present invention is not so limited and in alternate embodiments the annular groove 150 may be omitted or may only partially circumscribe the tubular sleeve 120. As discussed below, in one embodiment, the strip of resilient material 130 is in the form of an annular band that nests within the annular groove 150 of the tubular sleeve 120.

Referring to FIGS. 1, 2 and 4, the strip of resilient material 130 will be described in more detail. The strip of resilient material 130 is configured on the outer surface 126 of the tubular sleeve 120 to seal the aperture 140 and cover the latch 160. As noted above, in one embodiment, the strip of resilient material 130 forms an annular band that circumscribes the outer surface 126 of the tubular sleeve 120 and nests within the annular groove 150 formed in the outer surface 126 of the tubular sleeve 120. Preferably, the strip of resilient material 130 is over-molded to the tubular sleeve 120. The resilient material 130 can be an elastomeric material, such as a suitable thermoplastic elastomer (TPE) or other similar materials used in oral care products. The resilient material 130 may have a hardness durometer measurement ranging between A13 to A50 Shore hardness, although materials outside this range may be used. A suitable range of the hardness durometer rating is between A25 to A40 Shore hardness.

When the outer surface 126 of the tubular sleeve 120 is over-molded by the strip of resilient material 130, the strip of resilient material 130 may be a band that completely or partially circumferentially covers the proximal axial section 122 of the tubular sleeve 120. Further, the strip of resilient material 130 fills the aperture 140 surrounding the latch 160 on three sides making the flexibility of the latch 160 more rigid and making the handle 200 more difficult to remove from the cavity 121 of the tubular sleeve 120. This is advantageous because it helps to prevent unintended decoupling of the handle 200 and refill head 100. Further, the strip of resilient material 130 also seals the aperture 140 surrounding the latch 160 to prevent toothpaste and foreign material from entering the cavity 121 of the tubular sleeve 120. In alternate embodiments, the strip of resilient material 130 may be molded in different colors to identify different users if the powered toothbrush 1000 is being shared.

Referring to FIG. 5, a transverse cross sectional view of the powered toothbrush 1000 taken along the axis V-V in FIG. 4 is illustrated. As shown in FIG. 5, outer surface 221 of the stem 220 is in contact with the inner surface 125 of the tubular sleeve 120. Further, the locking lug 230 of the stem 220 is operably mated with the locking lug 161 of the latch 160, keeping the latch 160 biased in the locked state and preventing unintended decoupling of the handle 200 from the refill head 100. Moreover, since the latch 160 is biased in the locked state, the locking lug 161 of the latch 160 operably mates with the locking lug 230 of the stem 220 to axially retain the stem 220 within the cavity 121.

As further illustrated in FIG. 5, the axial rib 170 is configured to mate with the axial slot 240 to maintain relative rotational orientation between the stem 220 and the tubular sleeve 120. Therefore, when the head 100 and handle 200 are coupled together, the inner surface 125 of the tubular sleeve 120 and the outer surface 222 of the stem 220 are keyed to maintain relative rotational orientation between the stem 220 and the tubular sleeve 120.

A method of coupling and uncoupling the refill head 100 and the handle 200 will be described. In FIG. 1, the powered toothbrush 1000 is illustrated wherein the refill head 100 is not coupled to the handle 200, but is in axial alignment with the handle 200 so that such coupling can be effectuated. In FIG. 4, the powered toothbrush 1000 is illustrated wherein the refill head 100 is coupled to the handle 200 according to an embodiment of the present invention.

To assemble the refill head 100 to the handle 200, the tubular sleeve 120 is placed on the stem 220 and rotated until axial rib 170 aligns with the axial slot 240 of locking lug 230. As the refill head 100 is pressed downward on the stem 220 of the handle 200, the locking lug 161 of the latch 160 presses outwardly stretching the strip of resilient material as the locking lug 161 of the latch 160 moves over the lower surface 232 of the locking lug 230 of the stem 220 and snaps into a locked position. Since the latch 160 is biased in the locked state, the locking lug 161 of the latch 160 operably mates with the locking lug 230 of the stem 220 to axially retain the stem 220 within the cavity 121. Further, since the axial rib 170 is aligned with the axial slot 240, relative rotation orientation between the stem 220 and the tubular sleeve 120 is maintained.

Additionally, it should be noted that when the refill head 100 is coupled to the handle 200, only the distal section 224 of the stem 220 is in intimate contact with the inner surface 125 of the tubular sleeve 120, thereby minimizing vibration below the distal section 224 of the stem 220. This minimizes the vibration felt by the gripping portion 210 of the handle 200. The present design minimizes contact between the stem 220 and the tubular sleeve 120 below the distal section 224 of the stem 220 by utilizing the latch 160 on the tubular sleeve 120 that has minimal contact with the stem 220.

To decouple the refill head 100 from the stem 220 of the handle 200 of the powered toothbrush 1000, the consumer pulls upward on the refill head 100 causing the locking lug 161 of the latch 160 to ride up and over the lower surface 232 of the locking lug 230 of the stem 220. While the locking lug 161 of the latch 160 is riding over the lower surface 232 of the locking lug 230, the latch 160 is pressed outwardly, stretching the strip of resilient material 130 and allowing the decoupling of the refill head 100 from the stem 220.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

While the foregoing description and drawings represent the exemplary embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A toothbrush comprising:
a handle comprising:
a gripping portion; and
a stem extending from the gripping portion, the stem extending along an axis, the stem comprising a locking lug extending radially outward from an outer surface of the stem;
a refill head detachably coupled to the handle, the refill head comprising:
a head portion comprising a plurality of tooth cleaning elements;
a tubular sleeve coupled to the head portion, the tubular sleeve having a cavity in which the stem is disposed, the tubular sleeve comprising an aperture defining a latch in the tubular sleeve, the latch comprising a locking lug protruding into the cavity; and
wherein the locking lug of the latch operably mates with the locking lug of the stem to axially retain the stem within the cavity.

2. The toothbrush according to claim 1 further comprising a strip of resilient material on an outer surface of the tubular sleeve that seals the aperture and covers the latch.

3. The toothbrush according to claim 2 wherein the strip of resilient material forms an annular band that circumscribes the outer surface of the tubular sleeve, the annular band nests within an annular groove formed in the outer surface of the tubular sleeve, the latch defined in a floor of the groove.

4. The toothbrush according to claim 1 wherein the aperture is a substantially U-shaped aperture or a substantially V-shaped aperture.

5. The toothbrush according to claim 1 wherein the latch extends from a proximal edge to a distal edge, the proximal edge forming a living hinge and the distal edge being a free edge.

6. The toothbrush according to claim 1 wherein the locking lug of the stem comprises an upper surface that is oblique to the axis and a lower surface that is substantially perpendicular to the axis.

7. The toothbrush according to claim 1 wherein the locking lug is an annular flange circumscribing the stem.

8. The toothbrush according to claim 1 wherein the inner surface of the tubular sleeve and the outer surface of the stem are keyed to maintain relative rotational orientation between the stem and the tubular sleeve.

9. The toothbrush according to claim 8 wherein the stem comprises an axial slot, the tubular sleeve comprises an axial rib that mates with the axial slot to maintain relative rotational orientation between the stem and the tubular sleeve.

10. The toothbrush according to claim 1 wherein the latch is integrally molded with the tubular sleeve.

11. The toothbrush according to claim 2 wherein the strip of resilient material is over-molded to the tubular sleeve.

12. The toothbrush according to claim 1 wherein the latch flexes radially outward during loading and unloading of the refill head to the handle due to contact between the locking lug of the stem and the locking lug of the latch.

13. The toothbrush according to claim 2 wherein the resilient material is a thermoplastic elastomer and the tubular sleeve is formed of a hard plastic.

14. The toothbrush according to claim 1 wherein the latch is biased in a locked state in which the locking lug of the latch operably mates with the locking lug of the stem to axially retain the stem within the cavity

15. The toothbrush according to claim 1 wherein the aperture has a closed perimeter.

16. The toothbrush according to claim 1 wherein the locking lug of the stem is located on a base portion of the stem and the latch is located on a proximal portion of the refill head.

17. The toothbrush according to claim 1 wherein the cavity of the tubular sleeve tapers from a proximal end of the cavity to a distal end of the cavity, the proximal end of the cavity having an opening for receiving the stem.

18. The toothbrush according to claim 1 wherein the handle comprises a power source and a vibratory element operably coupled to the power source.

19. The toothbrush according to claim 18 wherein the vibratory element is located within the stem.

20. The toothbrush according to claim 19 wherein only a distal section of the outer surface of the stem is in intimate surface contact with an inner surface of the tubular sleeve.

21. The toothbrush according to claim 1 wherein the cavity comprises a proximal axial section, a middle axial section, and a distal axial section, the latch located within the proximal axial section, the handle further comprising an alignment plug extending from a distal end of the stem that extends into the distal axial section.

22. A refill head for an oral care implement comprising:
a head portion;
a tubular sleeve coupled to the head portion, the tubular sleeve having a cavity extending along an axis, the tubular sleeve comprising an aperture defining a latch in the tubular sleeve, the latch comprising a locking lug protruding into the cavity; and
a resilient material disposed within and sealing the aperture; and
wherein the latch is configured to flex radially outward from a locked state to an unlocked state, the latch biased into the locked state.

23. The refill head according to claim 22 wherein the resilient material covers the latch.

24. The refill head according to claim 23 wherein the resilient material is in the form of a strip that at least partially circumscribes an outer surface of the tubular sleeve.

25. The refill head according to claim 24 wherein the strip nests within a groove formed in the outer surface of the tubular sleeve, the latch defined in a floor of the groove.

26. The refill head according to claim 22 wherein the aperture is a substantially U-shaped aperture or a substantially V-shaped aperture.

27. The refill head according to claim 22 wherein the latch extends from a proximal edge to a distal edge, the proximal edge forming a living hinge and the distal edge being a free edge.

28. The refill head according to claim 22 wherein the tubular sleeve comprises an axial rib for maintaining relative rotational orientation between the refill head and a handle of the oral care implement when the refill head is detachably coupled to the handle.

29. The refill head according to claim 22 wherein the latch is integrally molded with the tubular sleeve.

30. The refill head according to claim 22 wherein the resilient material is over-molded to the tubular sleeve.

31. The refill head according to claim 22 wherein the resilient material is a thermoplastic elastomer and the tubular sleeve is formed of a hard plastic.

32. The refill head according to claim 22 wherein the aperture has a closed perimeter.

33. The refill head according to claim 22 wherein the latch is located on a proximal portion of the refill head.

34. A refill head for an oral care implement comprising:
a head portion;
a tubular sleeve coupled to the head portion, the tubular sleeve having a cavity extending along an axis, the tubular sleeve comprising a closed-perimeter aperture defining a latch in the tubular sleeve, the latch comprising a locking lug protruding into the cavity; and
a resilient material sealing the aperture.
